(19) United States
(12) Patent Application Publication
(10) Pub. No.: US 2026/0210225 A1
(43) Pub. Date: Jul. 23, 2026

(54) DISTRIBUTED ELECTRICAL INVERSION FOR WELLBORE SERVICING EQUIPMENT

(71) Applicant: Halliburton Energy Services, Inc., Houston, TX (US)

(72) Inventors: Glenn Howard Weightman, Duncan, OK (US); Carlos Alfredo Vallejo Gordon, Houston, TX (US); Moses Ling, Houston, TX (US); Joanel Antonio Cazarin Garcia, Houston, TX (US)

(21) Appl. No.: 19/028,345

(22) Filed: Jan. 17, 2025

(51) Int. Cl. E21B 43/26; H02K 7/00; H02K 7/04; H02K 7/18

(52) U.S. Cl. CPC E21B 43/2607; H02K 7/003; H02K 7/04; H02K 7/1823

(57) ABSTRACT

An apparatus for processing fracking fluid includes a platform; an enclosure disposed on the platform; a rectifier disposed inside the enclosure; a DC bus electrically coupled to the rectifier and disposed inside the enclosure; a DC distribution electrically coupled to the DC bus and disposed inside the enclosure; and inverters electrically coupled to the DC distribution and disposed on the platform and outside of the enclosure; motors electrically coupled to the inverters and disposed on the platform; and loads mechanically coupled to the motors and disposed on the platform.

### BACKGROUND

Balancing electrical equipment on a platform (such as a blender trailer) can present challenges due to the need to accommodate heavy, bulky equipment in a confined space. The varying weight and dimensions of these components may lead to uneven distribution of mass and/or raised center of gravity, which may increase the risk of instability or tipping. The system and method of the present disclosure may address these issues.

### BRIEF DESCRIPTION OF THE DRAWINGS

For a more complete understanding of the present disclosure, reference is now made to the following brief description, taken in connection with the accompanying drawings and detailed description, wherein like reference numerals represent like parts.

FIG. 1 is a schematic diagram of mixing equipment and a frac spread, according to an embodiment of the present disclosure;

FIG. 2 is a schematic diagram of a well system, according to an embodiment;

FIG. 3 is a schematic diagram of the device and possible power sources, according to an embodiment;

FIG. 4 is a schematic diagram of a VFD, according to an embodiment;

FIG. 5 is a schematic diagram of a blender, according to an embodiment;

FIG. 6 is a schematic diagram of a blender, according to another embodiment;

FIG. 7 is a perspective view of a blender, according to an embodiment;

FIG. 8 is a perspective phantom view of an enclosure, according to an embodiment;

FIG. 9 is a perspective view of components inside the enclosure, according to an embodiment; and

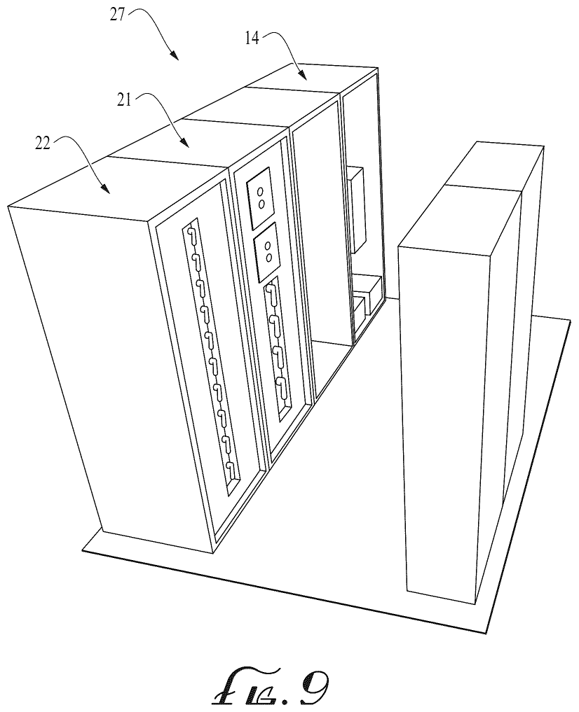

FIG. 10 is a flow diagram of a method for balancing a platform for processing fracking fluid.

### DETAILED DESCRIPTION

It should be understood at the outset that although illustrative implementations of one or more embodiments are illustrated below, the disclosed systems and methods may be implemented using any number of techniques, whether currently known or not yet in existence. The description that follows includes example systems, methods, techniques, and program flows that embody aspects of the disclosure. However, it is understood that this disclosure may be practiced without these specific details. For brevity, well-known steps, protocols, structures, and techniques have not been shown in detail in order not to obfuscate the description. The disclosure should in no way be limited to the illustrative implementations, drawings, and techniques illustrated below, but may be modified within the scope of the appended claims along with their full scope of equivalents.

The system of the present disclosure may comprise an electric motor that spins one or more hydraulic pumps which generates hydraulic fluid flow at a desired pressure and flow rate. The hydraulic prime movers may use the hydraulic flow to generate rotational or linear motion to operate physical loads such as agitators, chemical pumps, augers, etc. Inverters may be placed near the prime movers. An enclosure may distribute DC power to individual inverters that are placed close to the prime movers. In some embodiments, a portion of the DC distribution is located close to a plurality of inverters, motors, and loads. Additional components of the system may include line filters, which may be used with the rectifier, and a precharge circuit. The precharge circuit may be used to slowly charge capacitors on the DC bus prior to full operation. As used herein, the term “rectifier” generally refers to a circuit that converts AC power to DC. Some examples of a rectifier may be a diode rectifier, an active front end (AFE), or the like. The input to the rectification may be, for example, single phase AC, three-phase AC, multiple three-phase, or phase-shifted AC. Although several examples of the electronic configuration disclosed herein focuses on the electric blending applications, the same or similar electronic configuration may be applicable to other wellbore servicing equipment. For example, the same or similar electronic configuration could be applied to electric fracking applications such as boost pump skids, gel blenders, dry-gel blenders, liquid additive skids, sand handling equipment, electric pumping units, valve manifolds, and the like. As used herein, the terms “fracking fluid” and “fracturing fluid” are used interchangeably.

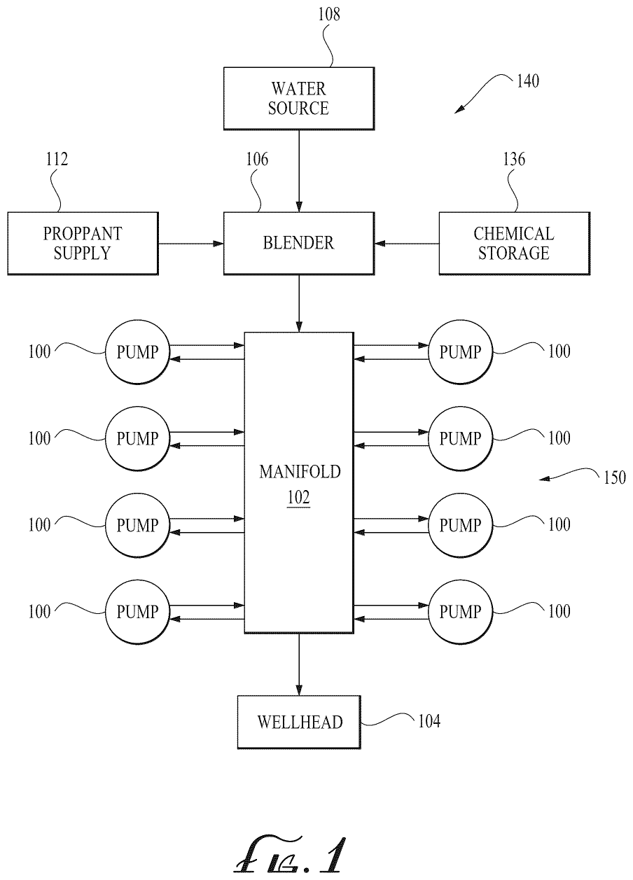

Referring FIG. 1, exemplary mixing equipment 140 and a frac spread 150 are shown. In the frac spread 150, pumps 100 may be connected to a central manifold 102. The pumps 100 may pump fracturing fluid, which may include proppant. The proppant may be sand, for example. The manifold 102 may be a trailer system that transfers high-pressure fracturing fluid to a wellhead 104 and downhole to a perforated zone for fracturing.

The mixing equipment may include a water source 108, a chemical storage 136, a proppant supply 112, and a blender 106. The manifold 102 may transfer fracturing fluid from the blender 106 to the pumps 100. The blender 106 may combine gelling agents and/or chemical additives from the chemical storage 136 and/or proppant from the proppant supply 112. At the blender 106, proppant may meter from proppant supply 112 into the mixture to become fracturing fluid that feeds into the pumps 100.

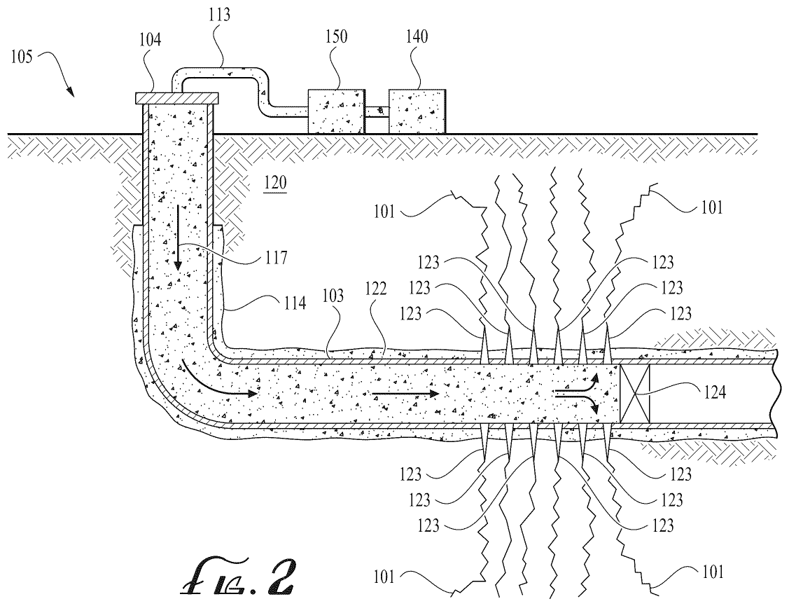

Referring to FIG. 2, an exemplary well system 105 that may be used to introduce proppant 116 into fractures 101 is shown. The well system 105 may include the mixing equipment 140, the frac spread 150, and/or a wellbore supply conduit 113. The frac spread 150 may be fluidly coupled with the wellbore supply conduit 113 to communicate a fracturing fluid, which may include proppant, into wellbore the 114.

The well system 105 may pump the fracturing fluid 117 into the subterranean formation 120 surrounding the wellbore 114. The wellbore 114 may include horizontal, vertical, slanted, curved, and/or other types of wellbore geometries and orientations, and the proppant may generally be applied to subterranean formation 120 surrounding any portion of wellbore 114, including the fractures 101. The wellbore 114 may include the casing 103 that may be cemented (or otherwise secured) to the wall of the wellbore 114 by cement sheath 122. Perforations 123 may allow communication between the wellbore 114 and the subterranean formation 120. The perforations 123 may penetrate casing 103 and cement sheath 122, allowing communication between the interior of the casing 103 and the fractures 101. A plug 124 may be disposed in wellbore 114 below the perforations 123.

A perforated interval of interest (e.g., an interval of wellbore 114 including the perforations 123) may be isolated with the plug 124. A pad or pre-pad fluid may be pumped into the subterranean formation 120 at a pumping rate and pressure at or above the fracture gradient to create and maintain at least one fracture 101 in subterranean formation 120. Then, proppant 116 may be mixed with an aqueous based fluid via mixing equipment 140, thereby forming a fracturing fluid. The fracturing fluid may be pumped via the frac spread 150 down the interior of the casing 103 and into subterranean formation 120 at or above a fracture gradient of the subterranean formation 120. Pumping the fracturing fluid at or above the fracture gradient of the subterranean formation 120 may create (or enhance) at least one fracture (e.g., fractures 101) extending from the perforations 123 into the subterranean formation 120.

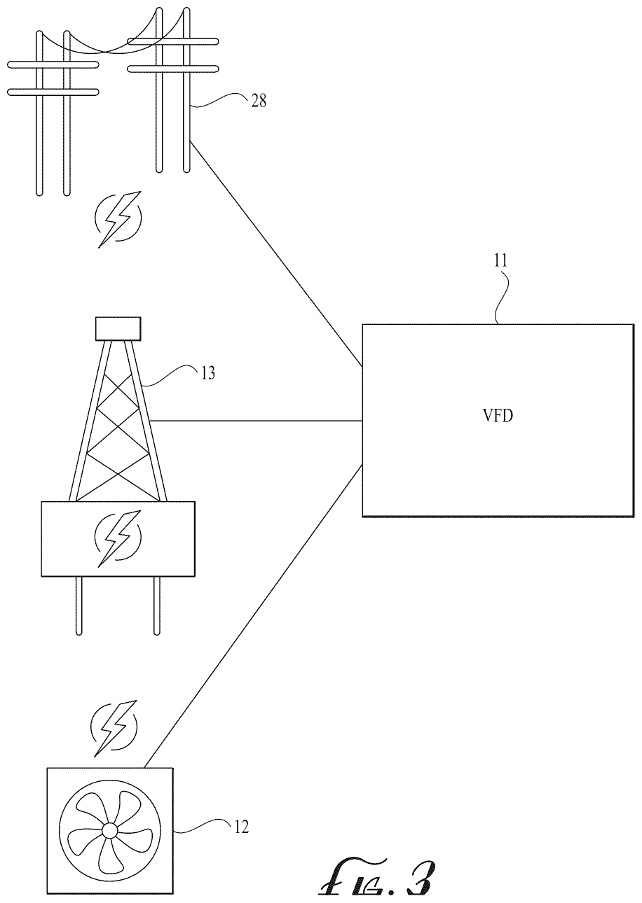

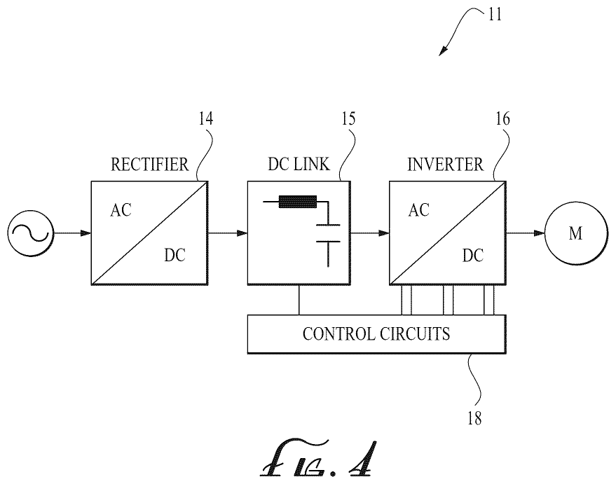

Referring to FIGS. 3-4, the system of the present disclosure may include a VFD 11. The VFD 11 may obtain power from any suitable source such as a turbine generator 12 (e.g., a natural gas turbine generator), drilling rig power 13, a power grid 28 (e.g., a municipal power grid or a microgrid), or the like. A rectifier 14 may convert AC power to DC power. The DC current may flow through a DC link 15 to an inverter 16, which may convert DC power to AC power. AC power may then be supplied to the motor 17. Control circuits 18 may control the DC link and/or the inverter 16. The control circuit 18 may be involved in a controlling the voltage and/or frequency of AC current output to the motor 17 for controlling the speed of the motor.

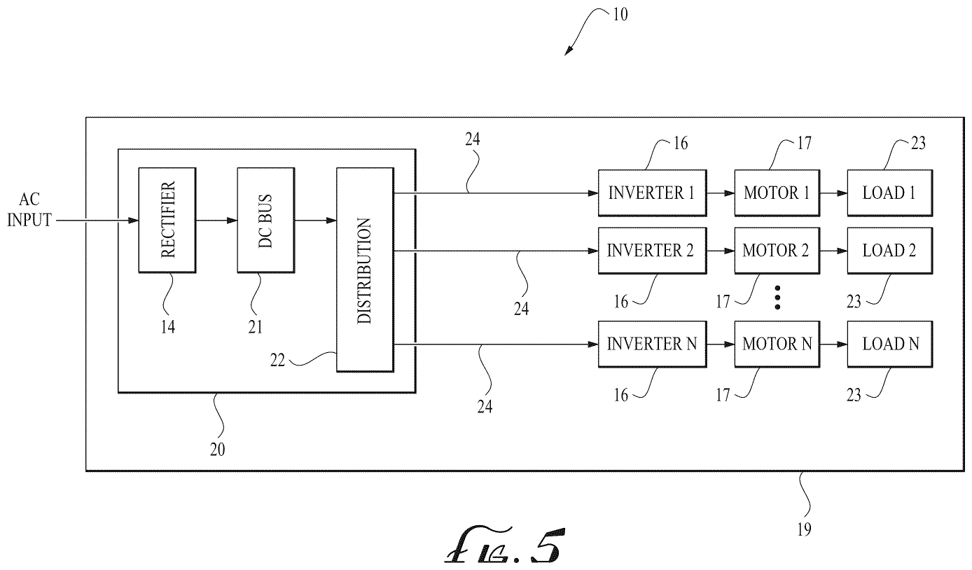

Referring to FIG. 5, an apparatus 10 for processing fracking fluid is shown. The apparatus 10 may be, for example, a blender (e.g., blender 106 as shown in FIGS. 1-2), a pump (e.g., pump 100 as shown in FIGS. 1-2), or another wellbore service device. The apparatus 10 may include a platform 19 and an enclosure 20 disposed on the platform 19. The apparatus 10 may further include a rectifier 14 disposed inside the enclosure 20; a DC bus 21 electrically coupled to the rectifier 14 and disposed inside the enclosure 20; a DC distribution 22 electrically coupled to the DC bus 21 and disposed inside the enclosure 20; inverters 16 electrically coupled to the DC distribution 22 and disposed on the platform 19 and outside of the enclosure 20; motors 17 electrically coupled to the inverters 16 and disposed on the platform 19; and/or loads 23 mechanically coupled to the motors 17 and disposed on the platform 19. The loads 23 may comprise, for example, pumps and/or blowers. There may be any suitable number of inverters, motors, and loads. For example, there may be one, two, three, four, five, six, seven, eight, nine, ten, or more inverters, motors, and/or loads. In some embodiments, the DC distribution 22 may be omitted. Although in FIG. 5, the DC bus 21 is connected to the inverters 16 through the DC distribution 22 and the feeder lines 24, any connection between the DC bus 21 and the inverters 16 is within the scope of the present disclosure. As used herein, the term “distribution” is used broadly to refer to any component that distributes electricity. In some embodiments, the DC distribution 22 comprises a breaker box. Alternatively, the DC distribution 22 may comprise feeder lines leading from the DC bus 21 to the inverter 16. Although in the illustration of FIG. 5, the DC distribution 22 is shown as a separate element from the feeder lines 24, in some embodiments, the DC distribution 22 may comprise the feeder lines 24.

The platform 19 may comprise a skid or a trailer. The inverters 16 may be disposed proximate to the motors 17. For example, each inverter 16 may be disposed within a certain distance (e.g., within 10 feet) of the associated motors 17. The loads 23 may be mechanical devices configured to mix fracturing fluid. The enclosure 20 may be spaced apart from the motors 17. For example, the enclosure 20 may be spaced apart from the motors 17 by a certain distance (e.g., from a few feet to the full length between the enclosure 20 and the platform 19). The DC distribution 22 may be electrically coupled to the inverters 16 via the feeder lines 24. The feeder lines 24 may extend from inside of the enclosure 20 to outside of the enclosure 20. For example, the feeder lines 24 may extend through one or more holes in the enclosure 20. There may be two feeder lines 24 leading to each inverter (e.g., a positive line and a negative line). The inverters 16 may be liquid cooled.

The spinning motor 17 may cause the voltage at the DC post rise. To prevent this, a resister can be used. There may be are choppers (e.g., break resisters) at the inverters 16 for dissipation. In some embodiments, the inverters and motors can be one module.

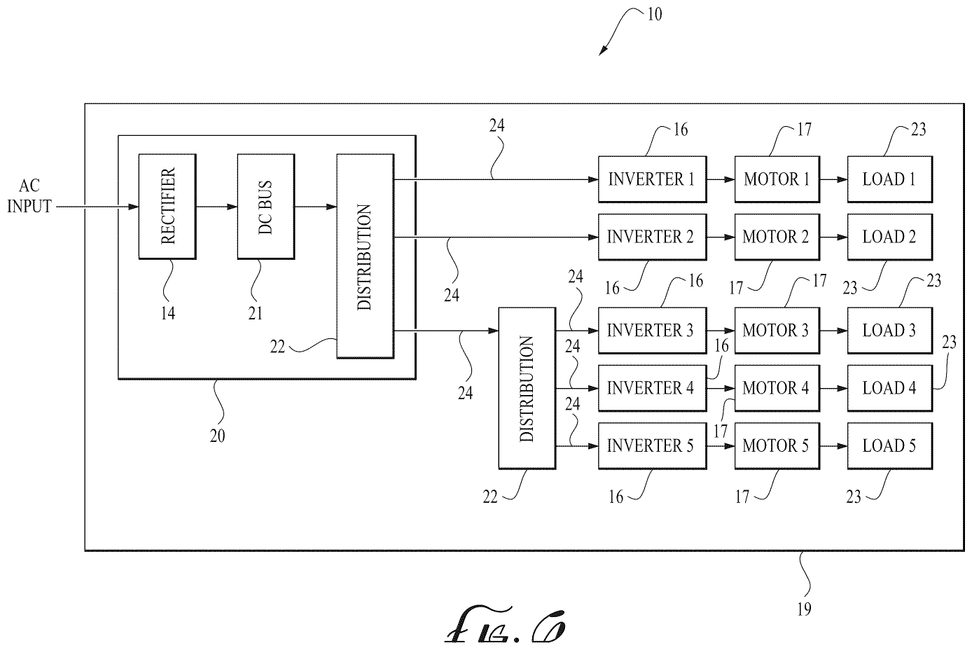

Referring to FIG. 6, the apparatus 10 may further include another DC distribution 22 outside of the enclosure 20. The DC distribution 22 outside of the enclosure may be disposed between the DC distribution 22 inside the enclosure and at least one of the inverters 16. That is, a feeder line may extend from the DC distribution 22 that is inside the enclosure, through the enclosure, and to the distribution that is outside of the enclosure. Multiple feeder lines 24 may extend from the DC distribution 22 that is outside the enclosure to inverters 16. Those inverters 16 may each be electrically coupled to a motor that drives a load 23.

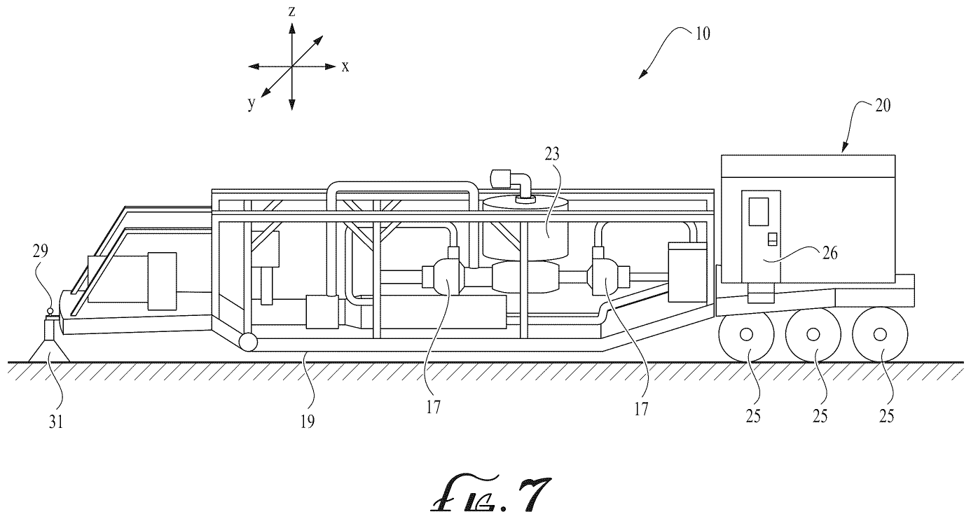

Referring to FIG. 7, the platform 19 may be a trailer. The trailer may be, for example, 20-53 feet long or 50 to 60 feet long (e.g., from end to end along the x-axis). The trailer may be, for example, 8 to 10 feet wide (e.g. from side to side along the y-axis). The trailer may be, for example, 13 to 15 feet high (e.g., from top to bottom along the z-axis). The trailer may have wheels 25 that are connected by axels. For example, the trailer may have three axels. A hitch 29 may be disposed on an opposite side of the trailer from the axels. A lift 31 may support the hitch 29 to keep the platform 19 level at the job site. Directly above the axels may be the enclosure 20. The enclosure 20 (e.g., a rectangular enclosure) may comprise a door 26 (e.g., for personnel to enter). The enclosure 20 could be, for example, 8-10 feet long (e.g., along the x-axis), 8-10 feet wide (e.g., along the y-axis) and 8-10 feet high (e.g., along the z-axis).

Weight may be approximately evenly distributed over the platform 19. For example, the inverters may be placed to balance the weight of the remaining components (e.g., the motors). The components may be arranged for a center of gravity to avoid overturning. For example, the center of gravity may be less than 10 feet above ground (e.g., greater than zero and less than about 10, 9, 8, 7, 6, 5, or 4 feet, for example).

A blending tub 23 may be placed, for example, 30-40 or 35-50 feet from the hitch 29 along the x-axis. The blending tub 23 may be, for example, 3-7 or 4-6 feet along the y-axis from the edge of the platform 19. The blending tub 23 may be, for example, 2-7 or 3-5 feet above the platform 19 along the z-axis. Pumps 17 may be placed, e.g., less than 5, 4, 3, 2, or 1 foot away in any of the x, y, or z directions from the blending tub 23. The pumps 17 may be disposed on either side of the blending tub 23. Each motor may be within 10 feet from a pump 17 that it drives in any of the x-y, or z directions. Each motor may have an inverter (e.g., that provides power to the motor) within 10 feet from the motor in any of the x, y, or z directions.

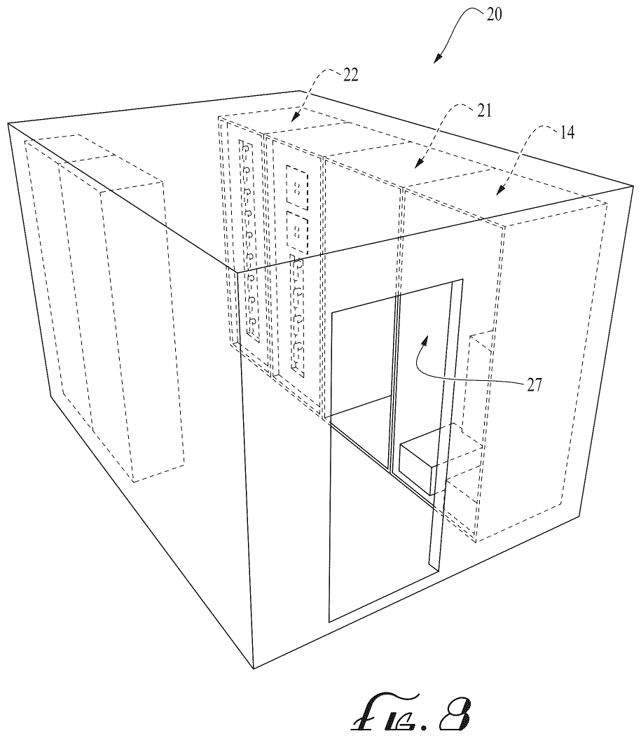

Referring to FIGS. 7-8, the enclosure 20 may contain cabinets 27, which may contain electrical equipment. Specifically, the cabinets 27 may contain the rectifier 14, the DC bus 21, and the DC distribution 22. The cabinets can be heated and/or cooled.

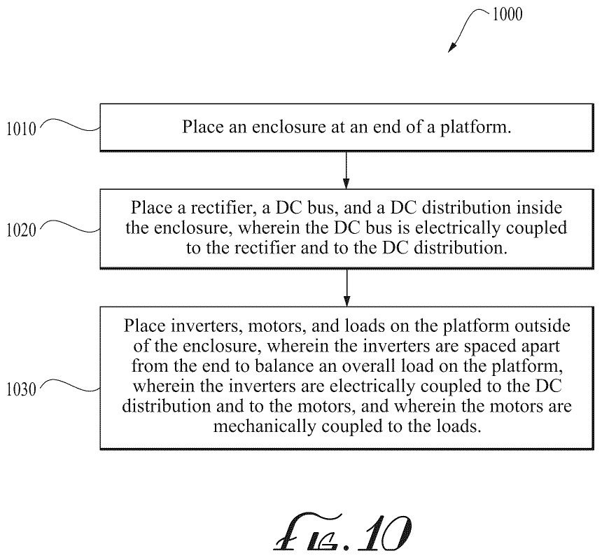

Referring to FIG. 10, a method 1000 for balancing a platform for processing fracking fluid may include the step 1010 of placing an enclosure on/at an end of a platform; the step 1020 of placing a rectifier, a DC bus, and a DC distribution inside the enclosure, wherein the DC bus is electrically coupled to the rectifier and to the DC distribution; and the step 1030 of placing inverters, motors, and loads on the platform outside of the enclosure, wherein the inverters are spaced apart from the end to balance an overall load on the platform, and wherein the inverters are electrically coupled to the DC distribution and to the motors, and wherein the motors are mechanically coupled to the loads. In some embodiments, the loads comprise a blender.

The loads may comprise one or more pumps (e.g., hydraulic fracking pumps) and/or one or more blowers. The platform may comprise a skid or the platform may comprise a trailer. The enclosure may be disposed directly over axels of the trailer. The inverters may be disposed proximate to the motors. The loads may be mechanical devices configured to mix fracturing fluid. The rectifier may be configured to receive AC power from a power source. The motors may be configured to receive AC power from the inverters. There may be another DC distribution disposed between the DC distribution and at least one of the inverters. The other DC distribution may be disposed outside of the enclosure. The enclosure may be spaced apart from the motors. The DC distribution may be electrically coupled to the inverters via feeder lines. The feeder lines may extend from inside of the enclosure to outside of the enclosure.

Advantageously, the system and method of the present disclosure can distribute 700 V DC current along the feeder lines, which avoids the need to distribute 480V AC RMS. This allows for smaller conductors with higher voltage. In addition, the feeder lines can each consist of one plus line and one negative line, which avoids the need for three or four lines, saving on weight. Moreover, by separating the components, packaging/placement options are expanded. By implementing the system and method of the present disclosure, improvements may be realized in system wiring, unit packaging, and weight distribution on mobile equipment.

### Additional Disclosure

The following are non-limiting, specific embodiments in accordance with the present disclosure:

In a first embodiment, an apparatus for processing fracking fluid comprises a platform; an enclosure disposed on the platform; a rectifier disposed inside the enclosure; a DC bus electrically coupled to the rectifier and disposed inside the enclosure and/or on the platform; a DC distribution electrically coupled to the DC bus and disposed inside the enclosure; and inverters electrically coupled to the DC distribution and disposed on the platform and outside of the enclosure; motors electrically coupled to the inverters and disposed on the platform; and loads mechanically coupled to the motors and disposed on the platform.

A second embodiment can include the apparatus of the first embodiment, wherein the apparatus comprises a blender.

A third embodiment can include the apparatus of the first or second embodiments, wherein the apparatus comprises a hydraulic fracking pump.

A fourth embodiment can include the apparatus of any of the first through third embodiments, wherein the loads comprise pumps or blowers.

A fifth embodiment can include the apparatus of any of the first through fourth embodiments, wherein the platform comprises a skid or a trailer.

A sixth embodiment can include the apparatus of any of the first through fifth embodiments, wherein the DC distribution comprises a breaker box.

A seventh embodiment can include the apparatus of any of the first through sixth embodiments, wherein the inverters are disposed proximate to the motors.

An eighth embodiment can include the apparatus of any of the first through seventh embodiments, wherein the loads are mechanical devices configured to mix fracturing fluid.

A ninth embodiment can include the apparatus of any of the first through eighth embodiments, wherein the rectifier is configured to receive AC power from a power source.

A tenth embodiment can include the apparatus of any of the first through ninth embodiments, wherein the motors are configured to receive AC power from the inverters.

An eleventh embodiment can include the apparatus of any of the first through tenth embodiments, further comprising another DC distribution disposed between the DC distribution and at least one of the inverters, wherein the other DC distribution is disposed outside of the enclosure.

A twelfth embodiment can include the apparatus of any of the first through eleventh embodiments, wherein the enclosure is spaced apart from the motors.

A thirteenth embodiment can include the apparatus of any of the first through twelfth embodiments, wherein the DC distribution is electrically coupled to the inverters via feeder lines.

A fourteenth embodiment can include the apparatus of any of the first through thirteenth embodiments, wherein the feeder lines extend from inside of the enclosure to outside of the enclosure.

In a fifteenth embodiment, a method for balancing a platform for processing fracking fluid comprises placing an enclosure at/on an end of a platform; placing a rectifier, a DC bus, and a DC distribution inside the enclosure, wherein the DC bus is electrically coupled to the rectifier and to the DC distribution; and placing inverters, motors, and loads on the platform outside of the enclosure, wherein the inverters are spaced apart from the end to balance an overall load on the platform, and wherein the inverters are electrically coupled to the DC distribution and to the motors, and wherein the motors are mechanically coupled to the loads.

A sixteenth embodiment can include the method of the fifteenth embodiments, wherein the loads comprise a blender.

A seventeenth embodiment can include the method of the fifteenth or sixteenth embodiments, wherein the loads comprise a hydraulic fracking pump.

An eighteenth embodiment can include the method of any of the fifteenth through seventeenth embodiments, wherein the loads comprise pumps or blowers.

A nineteenth embodiment can include the method of any of the fifteenth through eighteenth embodiments, wherein the platform comprises a skid.

A twentieth embodiment can include the method of any of the fifteenth through nineteenth embodiments, wherein the platform comprises a trailer, and the enclosure is disposed directly over axels of the trailer.

A twenty-first embodiment can include the method of any of the fifteenth through twentieth embodiments, wherein the inverters are disposed proximate to the motors.

A twenty-second embodiment can include the method of any of the fifteenth through twenty-first embodiments, wherein the loads are mechanical devices configured to mix fracturing fluid.

A twenty-third embodiment can include the method of any of the fifteenth through twenty-second embodiments, wherein the rectifier is configured to receive AC power from a power source.

A twenty-fourth embodiment can include the method of any of the fifteenth through twenty-third embodiments, wherein the motors are configured to receive AC power from the inverters.

A twenty-fifth embodiment can include the method of any of the fifteenth through twenty-fourth embodiments, further comprising another DC distribution disposed between the DC distribution and at least one of the inverters, wherein the other DC distribution is disposed outside of the enclosure.

A twenty-sixth embodiment can include the method of any of the fifteenth through twenty-fifth embodiments, wherein the enclosure is spaced apart from the motors.

A twenty-seventh embodiment can include the method of any of the fifteenth through twenty-sixth embodiments, wherein the DC distribution is electrically coupled to the inverters via feeder lines.

A twenty-eighth embodiment can include the method of any of the fifteenth through twenty-seventh embodiments, wherein the feeder lines extend from inside of the enclosure to outside of the enclosure.

While embodiments have been shown and described, modifications thereof can be made by one skilled in the art without departing from the spirit and teachings of this disclosure. The embodiments described herein are exemplary only and are not intended to be limiting. Many variations and modifications of the embodiments disclosed herein are possible and are within the scope of this disclosure. For example, the various elements or components may be combined or integrated in another system or certain features may be omitted or not implemented. Also, techniques, systems, subsystems, and methods described and illustrated in the various embodiments as discrete or separate may be combined or integrated with other techniques, systems, subsystems, or methods without departing from the scope of this disclosure. Other items shown or discussed as directly coupled or connected or communicating with each other may be indirectly coupled, connected, or communicated with. Method or process steps set forth may be performed in a different order. The use of terms, such as “first,” “second,” “third” or “fourth” to describe various processes or structures is only used as a shorthand reference to such steps/structures and does not necessarily imply that such steps/structures are performed/formed in that ordered sequence (unless such requirement is clearly stated explicitly in the specification).

Where numerical ranges or limitations are expressly stated, such express ranges or limitations should be understood to include iterative ranges or limitations of like magnitude falling within the expressly stated ranges or limitations (e.g., from about 1 to about 10 includes, 2, 3, 4, etc.; greater than 0.10 includes 0.11, 0.12, 0.13, etc.). For example, whenever a numerical range with a lower limit, Rₗ, and an upper limit, Ru, is disclosed, any number falling within the range is specifically disclosed. In particular, the following numbers within the range are specifically disclosed: R=Rₗ+k*(Rᵤ −Rₗ), wherein k is a variable ranging from 1 percent to 100 percent with a 1 percent increment, i.e., k is 1 percent, 2 percent, 3 percent, 4 percent, 5 percent, . . . 50 percent, 51 percent, 52 percent, . . . 95 percent, 96 percent, 97 percent, 98 percent, 99 percent, or 100 percent. Moreover, any numerical range defined by two R numbers as defined in the above is also specifically disclosed. Language of degree used herein, such as “approximately,” “about,” “generally,” and “substantially,” represent a value, amount, or characteristic close to the stated value, amount, or characteristic that still performs a desired function or achieves a desired result. For example, the language of degree may mean a range of values as understood by a person of skill or, otherwise, an amount that is +/−-10%.

Disclosure of a singular element should be understood to provide support for a plurality of the element. It is contemplated that elements of the present disclosure may be duplicated in any suitable quantity.

Use of broader terms such as comprises, includes, having, etc. should be understood to provide support for narrower terms such as consisting of, consisting essentially of, comprised substantially of, etc. When a feature is described as “optional,” both embodiments with this feature and embodiments without this feature are disclosed. Similarly, the present disclosure contemplates embodiments where this “optional” feature is required and embodiments where this feature is specifically excluded. The use of the terms such as “high-pressure” and “low-pressure” is intended to only be descriptive of the component and their position within the systems disclosed herein. That is, the use of such terms should not be understood to imply that there is a specific operating pressure or pressure rating for such components. For example, the term “high-pressure” describing a manifold should be understood to refer to a manifold that receives pressurized fluid that has been discharged from a pump irrespective of the actual pressure of the fluid as it leaves the pump or enters the manifold. Similarly, the term “low-pressure” describing a manifold should be understood to refer to a manifold that receives fluid and supplies that fluid to the suction side of the pump irrespective of the actual pressure of the fluid within the low-pressure manifold.

Accordingly, the scope of protection is not limited by the description set out above but is only limited by the claims which follow, that scope including all equivalents of the subject matter of the claims. Each and every claim is incorporated into the specification as embodiments of the present disclosure. Thus, the claims are a further description and are an addition to the embodiments of the present disclosure. The discussion of a reference herein is not an admission that it is prior art, especially any reference that can have a publication date after the priority date of this application. The disclosures of all patents, patent applications, and publications cited herein are hereby incorporated by reference, to the extent that they provide exemplary, procedural, or other details supplementary to those set forth herein.

Use of the phrase “at least one of” preceding a list with the conjunction “and” should not be treated as an exclusive list and should not be construed as a list of categories with one item from each category, unless specifically stated otherwise. A clause that recites “at least one of A, B, and C” can be infringed with only one of the listed items, multiple of the listed items, and one or more of the items in the list and another item not listed.

As used herein, the term “or” does not require selection of only one element. Thus, the phrase “A or B” is satisfied by either one or both elements from the set {A, B}, including multiples of either element; and the phrase “A, B, or C” is satisfied by any element from the set {A, B, C} or any combination thereof, including multiples of any element. A clause that recites “A, B, or C” can be infringed with only one of the listed items, multiple of the listed items, and one or more of the items in the list and another item not listed.

As used herein, the article “a” means “one or more.” As used herein, the article “an” means “one or more.” As used herein, the article “the” when referring to a singular noun means “the one or more.” Thus, the phrase “an element” means “one or more elements;” and the phrase “the element” means “the one or more elements.”

As used herein, the term “and/or” includes any combination of the elements associated with the “and/or” term. Thus, the phrase “A, B, and/or C” includes any of A alone, B alone, C alone, A and B together, B and C together, A and C together, or A, B, and C together.

1. An apparatus for processing fracking fluid, comprising:
a platform;
an enclosure disposed on the platform;
a rectifier disposed inside the enclosure;
a DC bus electrically coupled to the rectifier and disposed inside the enclosure;
a DC distribution electrically coupled to the DC bus and disposed on the platform; and
inverters electrically coupled to the DC distribution and disposed on the platform and outside of the enclosure;
motors electrically coupled to the inverters and disposed on the platform; and
loads mechanically coupled to the motors and disposed on the platform.

2. The apparatus of claim 1, wherein the loads comprise a blender.

3. The apparatus of claim 1, wherein the loads comprise a hydraulic fracking pump.

4. The apparatus of claim 1, wherein the loads comprise pumps or blowers.

5. The apparatus of claim 1, wherein the platform comprises a skid or a trailer.

6. The apparatus of claim 1, wherein the DC distribution comprises a breaker box.

7. The apparatus of claim 1, wherein the inverters are disposed proximate to the motors.

8. The apparatus of claim 1, wherein the loads are mechanical devices configured to mix fracking fluid.

9. The apparatus of claim 1, further comprising another DC distribution disposed between the DC distribution and at least one of the inverters, wherein the other DC distribution is disposed outside of the enclosure.

10. The apparatus of claim 1, wherein the DC distribution is electrically coupled to the inverters via feeder lines.

11. A method for balancing a platform for processing fracking fluid, comprising:
placing an enclosure at an end of a platform;
placing a rectifier, a DC bus, and a DC distribution inside the enclosure, wherein the DC bus is electrically coupled to the rectifier and to the DC distribution; and
placing inverters, motors, and loads on the platform outside of the enclosure, wherein the inverters are spaced apart from the end to balance an overall load on the platform, wherein the inverters are electrically coupled to the DC distribution and to the motors, and wherein the motors are mechanically coupled to the loads.

12. The method of claim 11, wherein the loads comprise a blender.

13. The method of claim 11, wherein the loads comprise a hydraulic fracking pump.

14. The method of claim 11, wherein the loads comprise pumps or blowers.

15. The method of claim 11, wherein the platform comprises a skid.

16. The method of claim 11, wherein the platform comprises a trailer, and the enclosure is disposed directly over axels of the trailer.

17. The method of claim 11, wherein the inverters are disposed proximate to the motors.

18. The method of claim 11, wherein the loads are mechanical devices configured to mix fracking fluid.

19. The method of claim 11, further comprising another DC distribution disposed between the DC distribution and at least one of the inverters, wherein the other DC distribution is disposed outside of the enclosure.

20. The method of claim 11, wherein the DC distribution is electrically coupled to the inverters via feeder lines.
